(19) United States
(12) Patent Application Publication
(10) Pub. No.: US 2016/0221268 A1
(43) Pub. Date: Aug. 4, 2016

(54) STACK FORMING APPARATUS AND NON-TRANSITORY COMPUTER READABLE MEDIUM STORING STACK FORMING PROGRAM

(71) Applicant: FUJI XEROX CO., LTD., Tokyo (JP)

(72) Inventors: Naoki HIJI, Kanagawa (JP); Takehito HIKICHI, Kanagawa (JP)

(21) Appl. No.: 14/843,294

(22) Filed: Sep. 2, 2015

(30) Foreign Application Priority Data
Feb. 4, 2015 (JP) 2015-020553

(51) Int. Cl. B29C 67/00; B29C 35/08

(52) U.S. Cl. CPC B29C 67/0092; B29C 67/0059; B29C 67/0088; B29C 35/0805; B29C 2035/0827; B29K 2023/12

(57) ABSTRACT

Provided is a stack forming apparatus including a molded article forming agent ejecting unit, that ejects a molded article forming agent for forming a three dimensional shaped product, onto a shaping stand, a surface modification unit that modifies wettability of surfaces of the molded article forming agent, and a control unit that controls the molded article forming agent ejecting section and the surface modification unit so that the three dimensional shaped product is formed by stacking the molded article forming agent through the repetition of ejection of the molded article forming agent and modification of the surface of the molded article forming agent.

### CROSS-REFERENCE TO RELATED APPLICATIONS

This application is based on and claims priority under 35 USC 119 from Japanese Patent Application No. 2015-020553 filed Feb. 4, 2015.

### BACKGROUND

### Technical Field

The present invention relates to a stack forming apparatus and a non-transitory computer readable medium storing a stack forming program.

### SUMMARY

According to an aspect of the invention, there is provided a stack forming apparatus including:

a molded article forming agent ejecting unit, that ejects a molded article forming agent for forming a three dimensional shaped product, onto a shaping stand;

a surface modification unit that modifies wettability of surfaces of the molded article forming agent; and

a control unit that controls the molded article forming agent ejecting section and the surface modification unit so that the three dimensional shaped product is formed by stacking the molded article forming agent through the repetition of ejection of the molded article forming agent and modification of the surface of the molded article forming agent.

### BRIEF DESCRIPTION OF THE DRAWINGS

Exemplary embodiments of the present invention will be described in detail based on the following figures, wherein:

FIG. 1 is a block diagram of a stack forming apparatus;

FIG. 2 is a side view of the stack forming apparatus;

FIG. 3 is a flowchart of a process that is executed by a controller;

FIG. 4A is a plan view of a three dimensional shaped product, and FIG. 4B is a side view of the three dimensional shaped product;

FIG. 5 is a side view of the stack forming apparatus;

FIG. 6 is sectional view taken along line A-A in FIG. 5;

FIG. 7 is a view that shows an ideal state of liquid droplets of an ejected molded article forming agent;

FIG. 8 is a view that shows a state in which liquid droplets of ejected molded article forming agent spread out;

(a) to (c) of FIG. 9 are views that show steps of stack forming;

(a) to (c) of FIG. 10 are views that show steps of stack forming in a case in which a water repellent material is not ejected;

(a) and (b) of FIG. 11 are views that illustrate a region in which a water repellent material is ejected;

(a) and (b) of FIG. 12 are views that illustrate a region in which a water repellent material is ejected;

(a) to (d) of FIG. 13 are views that show steps of stack forming in a case in which an amount of drops of liquid droplets of a water repellent material is set to be less than an amount of droplets of liquid droplets of a molded article forming agent; and

(a) to (e) of FIG. 14 are views that show steps of stack forming in a case in which a support material is ejected.

### DETAILED DESCRIPTION

Hereinafter, exemplary embodiments will be described with reference to the drawings.

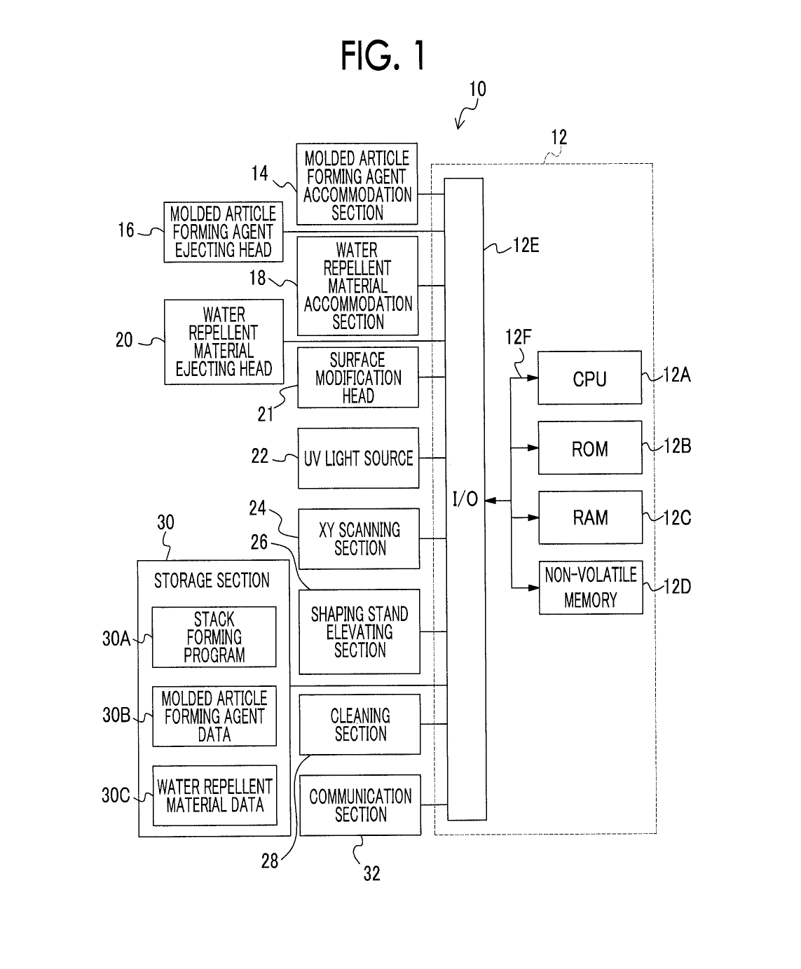

FIG. 1 shows a block diagram of a stack forming apparatus 10 according to the exemplary embodiment. As shown in FIG. 1, the stack forming apparatus 10 is configured to include a controller 12.

The controller 12 has a configuration in which a CPU (Central Processing Unit) 12A, a ROM (Read Only Memory) 12B, a RAM (Read Only Memory) 12C, a non-volatile memory 12D, and an input/output interface (I/O) 12E are respectively connected via a bus 12F.

Each functional section of a molded article forming agent accommodation section 14, a molded article forming agent ejecting head 16, a water repellent material accommodation section 18, a water repellent material ejecting head 20, a surface modification head 21, a UV light source 22, an XY scanning section 24, a shaping stand elevating section 26, a cleaning section 28, a storage section 30, a communication section 32, and the like, are connected to the I/O 12E.

The molded article forming agent accommodation section 14 accommodates a molded article forming agent for forming a three dimensional shaped product. The molded article forming agent is configured by, for example, a UV curable type resin that has a property of being cured when irradiated with UV (Ultra Violet) light, that is, when irradiated with ultraviolet rays.

More specifically, for example, a molded article forming agent in which a monomer and a urethane oligomer 1 are polymerized using a polymerization initiator, is used as the molded article forming agent. For example, isobornyl acrylate and 2-hydroxy-3-phenoxy propyl acrylate are used as the monomer. In addition, for example, a substance in which 2,4-tolylene diisocyanate is reacted with hydroxyethyl acrylate, is used as the urethane oligomer 1. In addition, for example, 1-hydroxycyclohexyl phenyl ketone is used as the polymerization initiator. The viscosity of a molded article forming agent that is configured by this kind of material is approximately 80 cp at room temperature, as an example, and the surface tension is approximately 34 dyn/cm, as an example.

The molded article forming agent ejecting head 16 ejects the molded article forming agent that is supplied from the molded article forming agent accommodation section 14 in accordance with instructions from the CPU 12A. For example, an ink jet head is used as the molded article forming agent ejecting head 16. Additionally, the amount of drops of molded article forming agent that are ejected from the molded article forming agent ejecting head 16 in a single ejection is, for example, approximately 100 pL.

The water repellent material accommodation section 18 accommodates a water repellent material for preventing the molded article forming agent from spreading. The water repellent material is configured by, for example, a UV curable type resin that has a property of being cured when irradiated with UV light in the same manner as the molded article forming agent. For example, a material that includes a fluorine compound or a silicone compound is used as the water repellent material.

More specifically, for example, a UV curable type resin in which a monomer and a urethane oligomer 1 are polymerized using a polymerization initiator, is used as the water repellent material. For example, isobornyl acrylate, 2-hydroxy-3-phenoxy propyl acrylate and octafluoropentyl acrylate are used as the monomer. Additionally, silaplane (manufactured by Chisso Corporation) FM-0711 may be used in place of octafluoropentyl acrylate. In addition, in the same manner as the molded article forming agent, for example, a substance in which 2,4-tolylene diisocyanate is reacted with hydroxyethyl acrylate, is used as the urethane oligomer 1. In addition, in the same manner as the molded article forming agent, for example, 1-hydroxycyclohexyl phenyl ketone is used as the polymerization initiator. The viscosity of a water repellent material that is configured by this kind of material is approximately 65 cp at room temperature, as an example, and the surface tension is approximately 25 dyn/cm, as an example.

Additionally, it is preferable that the molded article forming agent and the water repellent material are not compatible with one another. In addition, it is preferable that the required amounts of exposure of UV light per unit volume in order to cure the molded article forming agent and the water repellent material are equivalent.

The water repellent material ejecting head 20 ejects the water repellent material that is supplied from the water repellent material accommodation section 18 in accordance with instructions from the CPU 12A. For example, an ink jet head is used as the water repellent material ejecting head 20. Additionally, the amount of drops of water repellent material that are ejected from the water repellent material ejecting head 20 in a single ejection is, for example, the same as the molded article forming agent, approximately 100 pL.

Additionally, detailed description will be given below, but in a case in which a desired three dimensional shaped product is an overhanging shape, that is, a shape in which an upper side protrudes out, the water repellent material may have a function as a support material for supporting the portion that protrudes out.

The surface modification head 21 modifies so that the wettability of the surfaces of the molded article forming agent and the water repellent material ejected onto a shaping stand, is improved. In the exemplary embodiment, the surface modification head 21 is a plasma irradiation head that emits plasma, as an example. By irradiating the surfaces of the molded article forming agent and the water repellent material, which are ejected onto the shaping stand, with plasma, the wettability of the surfaces of the molded article forming agent and the water repellent material ejected onto the shaping stand are improved in comparison with the wettability thereof prior to the irradiation of plasma. Additionally, the plasma irradiation time is approximately 3 seconds, as an example. In addition, in place of a plasma irradiation head that emits plasma, the surface modification head 21 may be set as a UV ozone irradiation head that emits UV ozone.

The UV light source 22 irradiates the molded article forming agent that is ejected from the molded article forming agent ejecting head 16, and the water repellent material that is ejected from the water repellent material ejecting head 20 with UV light in a Z axis direction, thereby curing the molded article forming agent and the water repellent material. For example, a xenon lamp, an LED, a mercury lamp, a halogen lamp, a metal halide lamp, or the like is used as the UV light source 22. Additionally, the output of the UV light is, for example, approximately 2000 mW/cm², and the irradiation time is approximately 1 second.

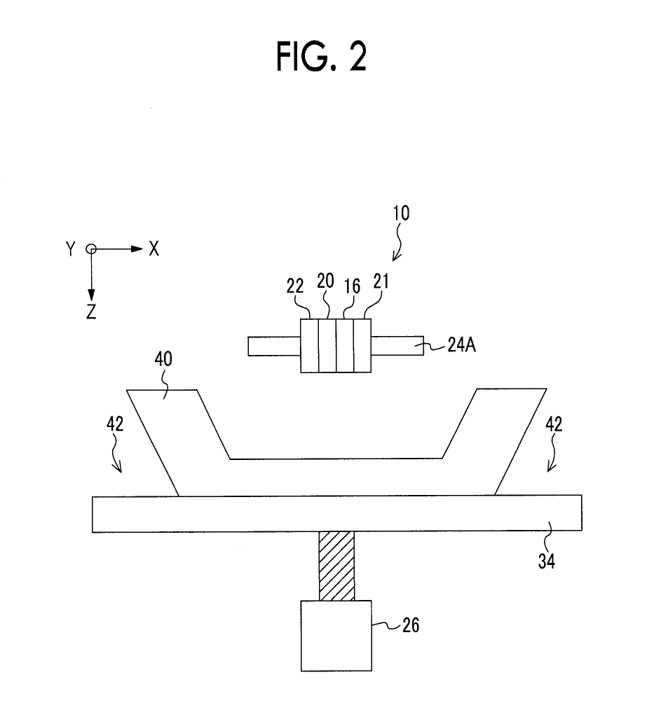

As shown in FIG. 2, the surface modification head 21, the molded article forming agent ejecting head 16, the water repellent material ejecting head 20 and the UV light source 22 are attached in this order to a scanning shaft 24A with which the XY scanning section 24 is provided. In a case in which the water repellent material does not also function as a support material, a support material ejecting head is further provided. Additionally, the order of the surface modification head 21, the molded article forming agent ejecting head 16, the water repellent material ejecting head 20 and the UV light source 22 is not limited to this.

The XY scanning section 24 drives the scanning shaft 24A so that the surface modification head 21, the molded article forming agent ejecting head 16, the water repellent material ejecting head 20 and the UV light source 22 move in an X direction and a Y direction, that is, scan an XY plane in two dimensions.

The shaping stand elevating section 26 causes a shaping stand 34, which is shown in FIG. 2, to ascend and descend in the Z axis direction. The CPU 12A controls the water repellent material ejecting head 20, the molded article forming agent ejecting head 16, the UV light source 22 and the surface modification head 21 so that the ejection of the water repellent material, the ejection of the molded article forming agent, the irradiation of the ejected molded article forming agent and water repellent material with UV light, and the modification of the surfaces of the molded article forming agent and the water repellent material that are cured by the irradiation of the UV light are repeated when a three dimensional shaped product is prepared. In addition, the CPU 12A controls the XY scanning section 24 so that the surface modification head 21, the molded article forming agent ejecting head 16, the water repellent material ejecting head 20 and the UV light source 22 scan the XY plane, and controls the shaping stand elevating section 26 so that the shaping stand 34 gradually descends in the Z axis direction.

Additionally, the CPU 12A controls the shaping stand elevating section 26 so that the molded article forming agent ejecting head 16, the water repellent material ejecting head 20, the surface modification head 21 and the UV light source 22 and the three dimensional shaped product do not come into contact with one another on the shaping stand 34, and so that a distance on the shaping stand 34 in the Z axis direction from the molded article forming agent ejecting head 16, the water repellent material ejecting head 20, the surface modification head 21 and the UV light source 22 to the three dimensional shaped product is greater than or equal to a predetermined distance when the three dimensional shaped product is formed.

The cleaning section 28 has a function of cleaning by suctioning material that is attached to the molded article forming agent ejecting head 16, the water repellent material ejecting head 20, the surface modification head 21 and the UV light source 22, and the like. For example, the cleaning section 28 is provided in a retreat region outside a scanning range of the molded article forming agent ejecting head 16, the water repellent material ejecting head 20, the surface modification head 21 and the UV light source 22, and executes cleaning after the molded article forming agent ejecting head 16, the water repellent material ejecting head 20, the surface modification head 21 and the UV light source 22 retreat to the retreat region when cleaning is executed.

The storage section 30 stores a stack forming program 30A which will be described below, molded article forming agent data 30B, and water repellent material data 30C. Additionally, the molded article forming agent data 30B is data that represents a region (coordinates) in which the molded article forming agent should be ejected, and the water repellent material data 30C is data that represents a region (coordinates) in which the water repellent material should be ejected. Additionally, in the exemplary embodiment, the region in which the water repellent material should be ejected is a region other than a region in which the molded article forming agent should be ejected.

The CPU 12A reads and executes the stack forming program 30A that is stored in the storage section 30. In addition, the stack forming program 30A may be stored on a recording medium such as a CD-ROM, and may be executed by being read by a CD-ROM drive or the like.

The communication section 32 is an interface for performing data communication with an external device that outputs the molded article forming agent data 30B of the three dimensional shaped product.

The CPU 12A manufactures a three dimensional shaped product by executing the stack forming program 30A in accordance with the molded article forming agent data 30B that is transmitted from the external device, and the water repellent material data 30C that is created based on the molded article forming agent data 30B.

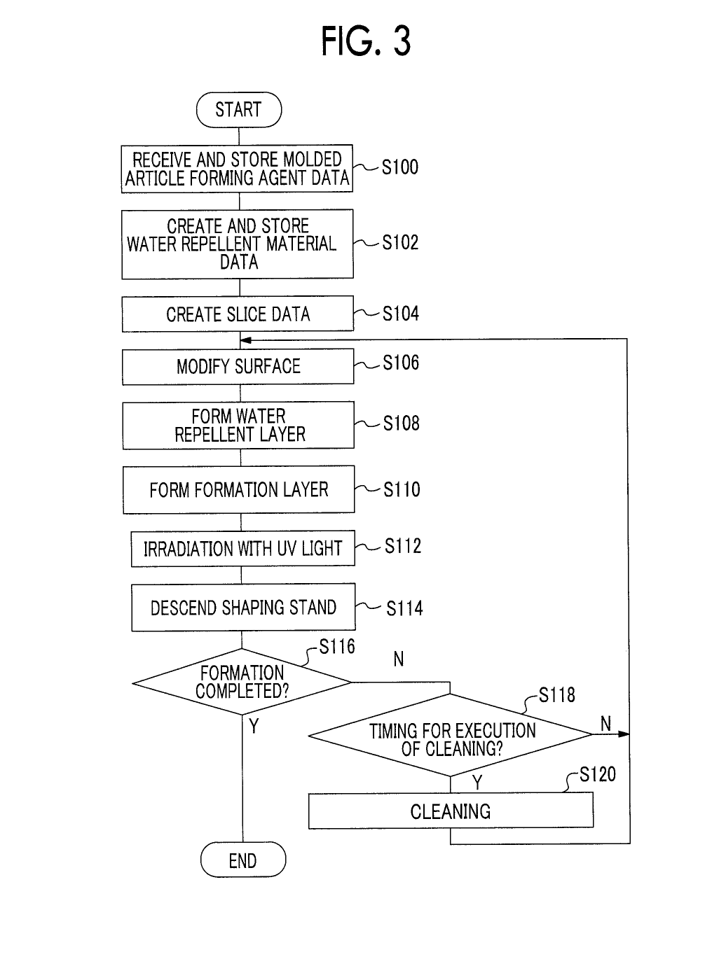

Next, the actions of the exemplary embodiment will be described. FIG. 3 shows a flowchart of the stack forming program 30A that is executed by the CPU 12A. Additionally, the process that is shown in FIG. 3 is executed when manufacture of the three dimensional shaped product is instructed from the external device.

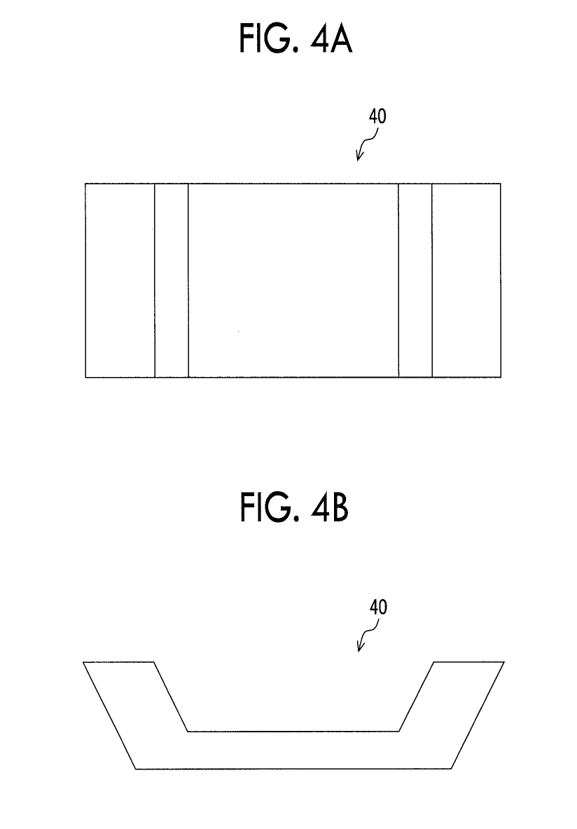

In addition, in the exemplary embodiment, as an example, a case in which a three dimensional shaped product 40 shown in FIGS. 4A and 4B is manufactured, will be described. FIG. 4A is a plan view of the three dimensional shaped product 40, and FIG. 4B is a side view of the three dimensional shaped product 40. As shown in FIG. 4B, the three dimensional shaped product 40 has a shape in which the shapes of both end sides extend in a diagonally upward direction from the bottom when viewed from a side surface, that is, an overhanging shape.

In Step S100, the molded article forming agent data 30B of the three dimensional shaped product 40 is received from the external device, and stored in the storage section 30. For example, STL (Standard Triangulated Language) format, which is a data format that expresses a three dimensional shape, is used as the format of the molded article forming agent data 30B of the three dimensional shaped product 40, but the format is not limited to this.

In Step S102, the water repellent material data 30C is created in accordance with the molded article forming agent data 30B that is received in Step S100. In the exemplary embodiment, the region in which the water repellent material should be ejected is a region other than a region in which the molded article forming agent should be ejected, and therefore, the water repellent material data 30C is created as data that represents a region other than the region in which the molded article forming agent should be ejected. In this manner, in order to create the water repellent material data 30C for ejecting the water repellent material automatically, it is not necessary for a user to perform an input operation such as indicating a region for ejecting the water repellent material. Additionally, the water repellent material data 30C that is prepared in advance may be received from an external device and stored in the storage section 30 without the water repellant material data 30C being created automatically.

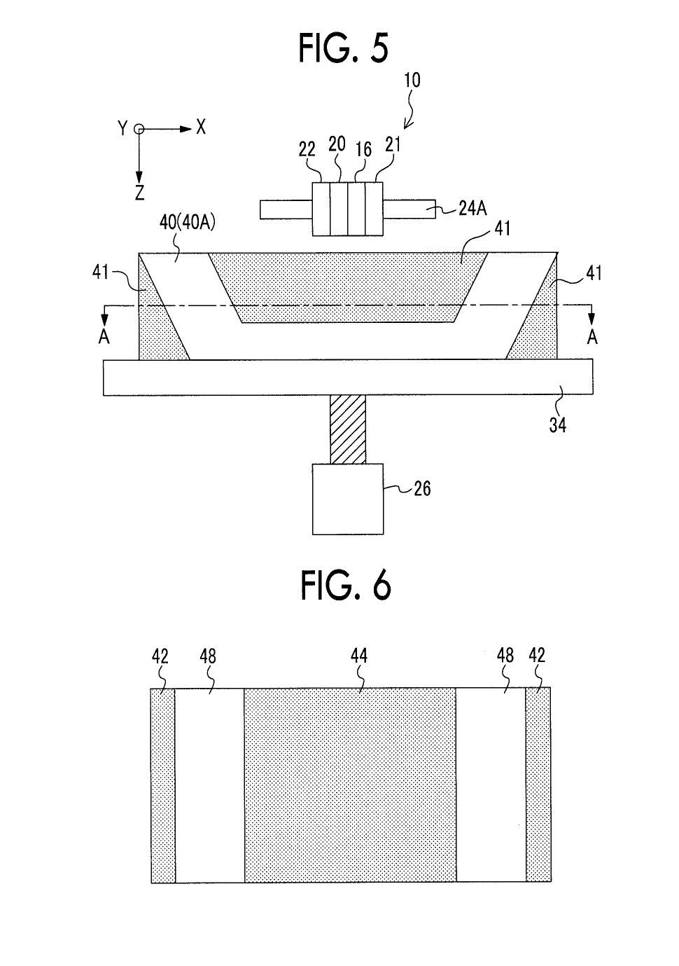

In Step S104, slice data, in which the three dimensional shaped product that is formed by the molded article forming agent and the water repellent material is sliced at the XY plane in the Z axis direction, that is, in a direction of stack, is created based on the molded article forming agent data 30B and the water repellant material data 30C. As a result of this, multiple items of slice data, in which the three dimensional shaped product 40 is sliced at the XY plane are created in the direction of stack. For example, as shown in FIG. 5, slice data of a sectional surface A-A of the three dimensional shaped product molded article forming agent that is formed by a molded article forming agent 40A and a water repellent material 41 is shown in FIG. 6. As shown in FIG. 6, the water repellent material 41 is ejected in regions 42 and 44, and the molded article forming agent 40A is ejected in a region 48. Additionally, as shown in FIG. 2, the water repellent material 41 that is ejected onto the region 42 in which a lower section is open space functions as a support material.

In Step S106, a surface modification process is executed. That is, the XY scanning section 24 is controlled so that the surface modification head 21 scans the XY plane, and the surface modification head 21 is controlled so that plasma is emitted from the surface modification head 21. Initially, since neither the molded article forming agent 40A nor the water repellent material 41 is ejected, the surface of the shaping stand 34 is modified.

In Step S108, a water repellent layer forming process is executed. That is, the XY scanning section 24 is controlled so that the water repellent material ejecting head 20 scans the XY plane, and the water repellent material ejecting head 20 is controlled so that the water repellent material 41 is ejected in accordance with the slice data created in Step S104.

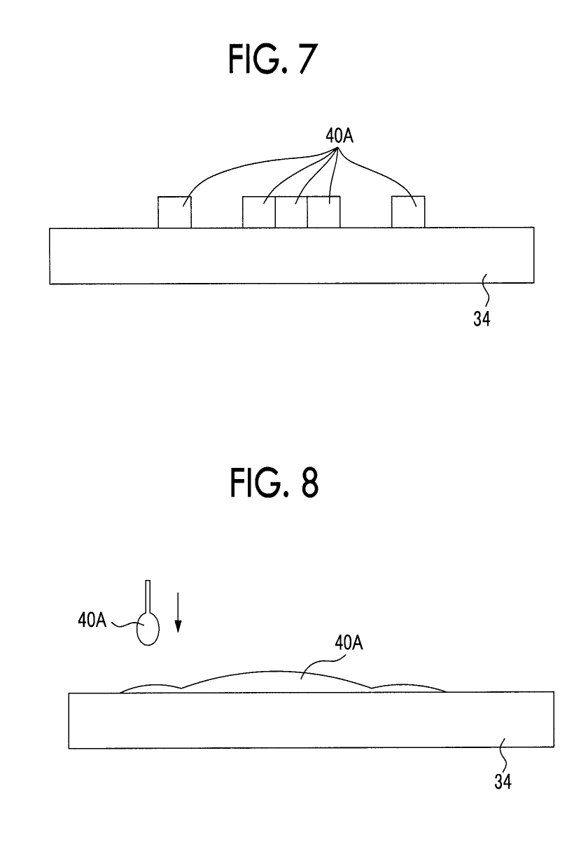

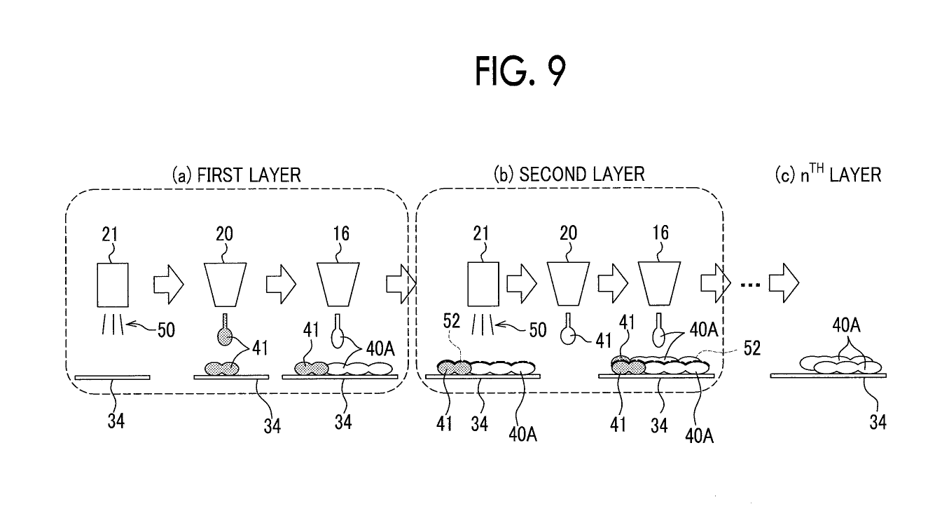

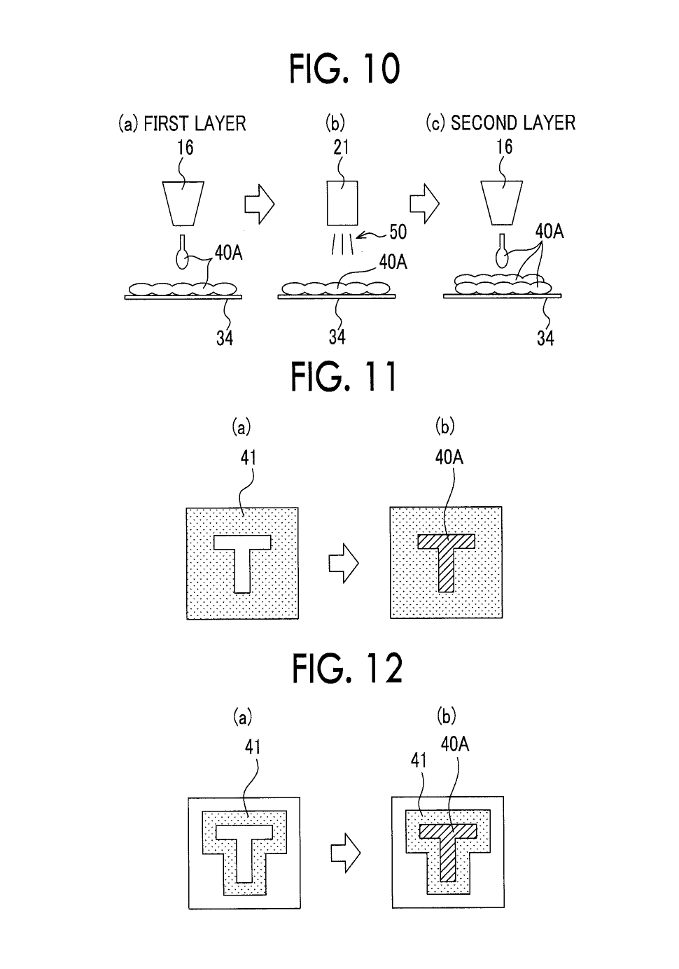

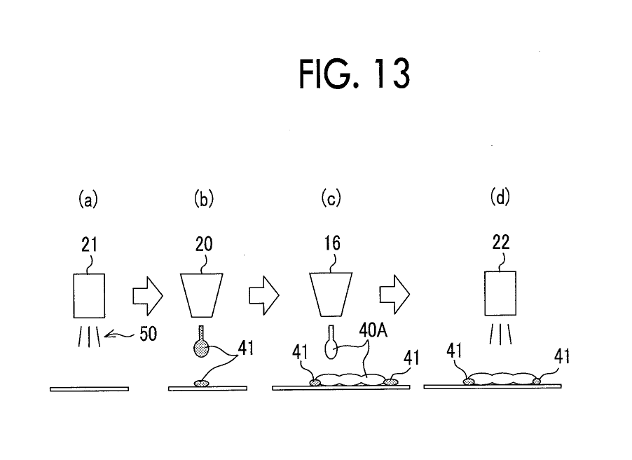

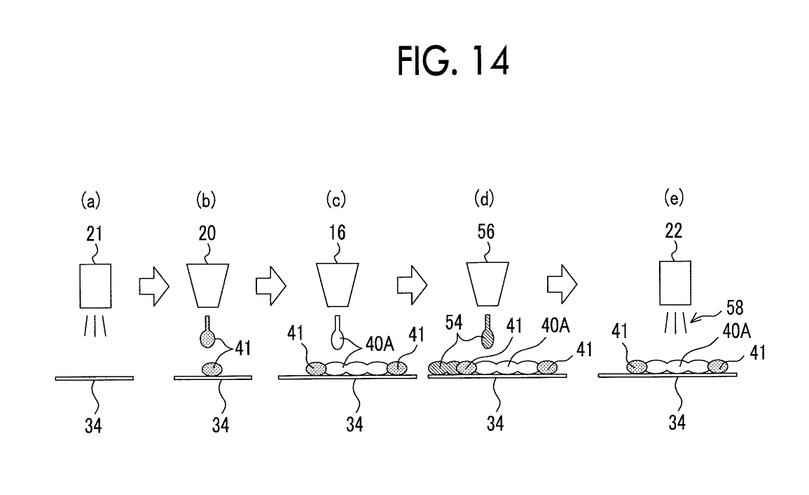

In Step S110, a formation layer forming process is executed. That is, the XY scanning section 24 is controlled so that the molded article forming agent ejecting head 16 scans the XY plane, and the molded article forming agent ejecting head 16 is controlled so that the molded article forming agent 40A is ejected in accordance with the slice data created in Step S104. As shown in FIG. 7, for example, in the ejected molded article forming agent 40A, a circumstance in which each liquid droplet does not spread is ideal. However, as shown in FIG. 8, the ejected molded article forming agent 40A spreads if only the molded article forming agent 40A is ejected, and mixes with molded article forming agent 40A that is ejected in the vicinity thereof. In contrast to this, in the exemplary embodiment, since the molded article forming agent 40A is ejected after forming a water repellent layer by ejecting the water repellent material 41 in a region other than a region in which the molded article forming agent 40A is ejected, a circumstance in which the ejected molded article forming agent 40A spreads and mixes with molded article forming agent 40A that is ejected in the vicinity thereof, is suppressed.

In Step S112, a UV light irradiation process is executed. That is, the XY scanning section 24 is controlled so that the UV light source 22 scans the XY plane, and the UV light source 22 is controlled so that UV light is emitted from the UV light source 22. As a result of this, the water repellent layer that is formed in Step S108 and the formation layer that is formed in Step S110 are cured.

In Step S114, the shaping stand elevating section 26 is controlled so that the shaping stand 34 descends by an amount of one layer in the Z axis direction.

In Step S116, it is determined whether or not the formation is complete, and the process moves to S118 if the formation is not complete and the present routine is completed if the formation is complete.

In Step S118, it is determined whether or not it is a timing to execute cleaning of the molded article forming agent ejecting head 16 and the water repellent material ejecting head 20. Further, in a case in which it is a timing to execute cleaning, the process moves to Step S120. Meanwhile, in a case in which it is not timing to execute cleaning, the process moves to Step S106, and a forming process of the next layer continues.

For example, each time a predetermined period of time elapses, each time a predetermined amount of at least either one of the molded article forming agent 40A or the water repellent material 41 is consumed, or the like may be included as examples of a timing to execute cleaning, but the timing is not limited to these.

In a case in which each time a predetermined period of time elapses is set as the timing to execute cleaning, for example, it is preferable that the period of time is changed to various periods of time, a state of blockages of the molded article forming agent ejecting head 16 and the water repellent material ejecting head 20 are measured, and the timing is set as the longest period of time during which blockages do not occur. The shorter the period of time is, the more a number of cleans increases, and therefore, an amount of time until the forming process is complete becomes longer. As a result of this, unnecessary cleaning is suppressed.

In Step S120, the XY scanning section 24 is instructed so that the molded article forming agent ejecting head 16 and the water repellent material ejecting head 20 move to the retreat region, and the cleaning section 28 is instructed so that cleaning of the molded article forming agent ejecting head 16 and the water repellent material ejecting head 20 is executed. As a result of this, the molded article forming agent ejecting head 16 and the water repellent material ejecting head 20 move to the retreat region, and the cleaning section 28 cleans the molded article forming agent ejecting head 16 and the water repellent material ejecting head 20. Additionally, in a case in which each time a predetermined amount of at least either one of the molded article forming agent 40A or the water repellent material 41 is consumed is set as the timing to execute cleaning, it may be configured so that only a head that ejects the material of which the predetermined amount has been consumed, is cleaned.

Additionally, after the completion of the forming process of FIG. 3, the water repellent material 41 is removed by a technique such as peeling away mechanically, peeling away due to heating, peeling away due to dissolving or the like. The water repellent material 41 may be peeled off easily since the strength thereof after curing by through the irradiation of UV light is weak in comparison with the molded article forming agent 40A.

In this manner, in the exemplary embodiment, the three dimensional shaped product is prepared through the stack of the molded article forming agent 40A and the water repellent material 41 by repeating surface modification, water repellent layer formation, formation layer formation and UV irradiation.

(a) to (c) of FIG. 9 show a summary of steps of stack forming. As shown in (a) to (c) of FIG. 9, firstly, in a first layer, the surface of the shaping stand 34 is modified as a result of a plasma 50 being emitted by the surface modification head 21. Thereafter, the water repellent material 41 is ejected onto the shaping stand 34 by the water repellent material ejecting head 20. Subsequently, the molded article forming agent 40A is ejected onto the shaping stand 34 by the molded article forming agent ejecting head 16. In this manner, since the water repellent layer is formed before the formation layer is formed, a circumstance in which adjacent ejected molded article forming agent 40A mixes together as a result of the molded article forming agent 40A spreading, the molded article forming agent 40A spreads further, and therefore, a resolution is decreased, is suppressed. Subsequently, UV light is emitted by the UV light source 22, and the molded article forming agent 40A and the water repellent material 41 are cured. Additionally, in (a) to (c) of FIG. 9, curing due to the irradiation of the UV light is omitted.

As shown in (a) to (c) of FIG. 9, in a second layer, the wettability of a surface 52 of the molded article forming agent 40A and the water repellent material of the first layer is improved as a result of the molded article forming agent 40A and the water repellent material 41 of the first layer being irradiated with the plasma 50 by the surface modification head 21. Thereafter, in the same manner as that of the first layer, the water repellent material 41 and the molded article forming agent 40A are ejected, and the water repellent layer and the formation layer are formed. After repeating this until an n^{th} layer, the three dimensional shaped product is prepared by removing the water repellent material 41.

For example, in a case in which the water repellent material 41 and the molded article forming agent 40A of the second layer are ejected without performing surface modification after ejecting the water repellent material 41 and the molded article forming agent 40A of the first layer, the water repellent material 41 and the molded article forming agent 40A of the second layer are repelled by the water repellency of the water repellent material 41 of the first layer, and there are cases in which it is not possible to form the water repellent layer and the formation layer of the second layer, but in the exemplary embodiment, since surface modification is performed after the formation of each layer, a circumstance in which the adhesiveness of each layer decreases, is suppressed. Accordingly, it is also possible to prepare an overhanging shape.

Additionally, in a case in which a material in which spreading is difficult, is used, the water repellent material ejecting head 20 may be omitted, and the formation of the water repellent layer may be omitted. In this case, as shown in (a) to (c) of FIG. 10, after the formation layer of the first layer is formed by ejecting the molded article forming agent 40A using the molded article forming agent ejecting head 16, the surface of the formation layer of the first layer is modified by emitting the plasma 50 using the surface modification head 21, and the formation layer of the first layer is cured by emitting UV light using the UV light source 22. Additionally, in (a) to (c) of FIG. 10, curing due to the irradiation of the UV light is omitted. Subsequently, the formation layer of the second layer is formed in the same manner as the first layer.

Even in a case in which only the formation layer is formed, since the adhesiveness between each formation layer is week and is likely to peel away after curing through the irradiation of UV light, a circumstance in which the adhesiveness between each formation layer decreases and is likely to peel away, is suppressed by executing surface modification between each formation layer.

In addition, in the exemplary embodiment, a case in which the water repellent material 41 also functions as a support material, and the water repellent material 41 is ejected in all regions other than a region in which the molded article forming agent 40A is ejected, is described. For example, as shown in (a) and (b) of FIG. 11, in a case in which a planar shape of a layer is the shape of the letter T, after ejecting the water repellent material 41 in all regions other than the shape of the T, the molded article forming agent 40A is ejected in the region of the shape of the T.

In this manner, the water repellant material may be ejected only in regions that are adjacent to regions in which the molded article forming agent 40A is ejected rather than ejecting the water repellent material 41 in all regions other than a region in which the molded article forming agent 40A is ejected. For example, as shown in (a) and (b) of FIG. 12, in a case in which a planar shape of a layer is the shape of the letter T, the water repellent material 41 is only ejected in regions that are adjacent to the shape of the T. In this case, the water repellent material 41 may remain without change, or may be peeled off.

In addition, in the exemplary embodiment, a case in which the amount of drops of the water repellent material 41 that are ejected from the water repellent material ejecting head 20 is substantially the same as the amount of drops of the molded article forming agent 40A that are ejected from the molded article forming agent ejecting head 16, is described, but as shown in (a) to (d) of FIG. 13, the amount of drops of the water repellent material 41 that are ejected from the water repellent material ejecting head 20 may be less than the amount of drops of the molded article forming agent 40A that are ejected from the molded article forming agent ejecting head 16. In this case, for example, the amount of drops of the water repellent material 41 that are ejected from the water repellent material ejecting head 20 is approximately 0 pL, and the amount of drops of the molded article forming agent 40A that are ejected from the molded article forming agent ejecting head 16 is approximately 100 pL. In this case, the water repellent material 41 is saved. In addition, when measured by the present inventors, the width of the finest line that is resolvable when drawing a striped pattern in which a ratio of lines and spaces is 1:1, that is, the width of the finest line in which the spaces between lines are recognizable, is approximately 250 μm. Meanwhile, in a case in which the amounts of drops of the water repellent material 41 and the molded article forming agent 40A are the same, the width of the finest line that is resolvable is approximately 500 μm.

In addition, in the exemplary embodiment, in a case in which the water repellent material 41 also functions as a support material is described, but as shown in (a) to (d) of FIG. 13, a configuration in which a support material ejecting head 56, which ejects a support material 54, may also be used. In this case, as shown in (a) to (d) of FIG. 13, each layer is formed by repeating surface modification using the surface modification head 21, ejection of the water repellent material 41 using the water repellent material ejecting head 20, ejection of the molded article forming agent 40A using the molded article forming agent ejecting head 16, ejection of the support material 54 using the support material ejecting head 56, and irradiation of UV light 58 using the UV light source 22.

Additionally, for example, a substance in which a monomer, multiple kinds of polypropylene glycol (PPG) with different number average molecular weights (Mn) and phenothiazine are polymerized using a polymerization initiator, is used as the support material 54. For example, N-hydroxy acrylamide is used as the monomer. In addition, for example, a PPG with an Mn of approximately 400 and a PPG with an Mn of approximately 1000 are used as the multiple kinds of PPG. In addition, for example, 1-hydroxycyclohexyl phenyl ketone is used as the polymerization initiator. For example, this kind of support material may be dissolved and removed through immersion in water for a few hours after the completion of the formation of the three dimensional shaped product.

In addition, solid ink may be used as the molded article forming agent 40A and the water repellent material 41. In this case, for example, a heating dispenser is used as the molded article forming agent ejecting head 16 and the water repellent material ejecting head 20. Additionally, if heated in advance, an ink jet head may be used. In addition, since the solid ink cures quickly, the UV light source 22 is omitted. In addition, for example, a substance in which octadecanol and viscosity-imparting material are mixed, is used as the molded article forming agent 40A. The viscosity of the molded article forming agent 40A in this case is approximately 11 cp at 80° C., as an example, and the surface tension thereof is approximately 35 dyn/cm, as an example. In addition, for example, a substance in which octadecanol, a viscosity-imparting material and a fluorine based surfactant are mixed, is used as the water repellent material 41. The viscosity of the water repellent material 41 in this case is approximately 11 cp at 80° C., as an example, and the surface tension thereof is approximately 24 dyn/cm, as an example. Additionally, in a case in which the water repellent material 41 also functions as the support material, for example, lauryl alcohol is used in place of octadecanol. The viscosity of the water repellent material 41 in this case is approximately 8 cp at 80° C., as an example, and the surface tension thereof is approximately 24 dyn/cm, as an example.

In addition, in the exemplary embodiment, a case in which the surface modification head 21, the molded article forming agent ejecting head 16, the water repellent material ejecting head 20 and the UV light source 22 move in the X direction and the Y direction, that is, scan the XY plane in two dimensions, is described, but a longitudinal configuration in which the surface modification head 21, the molded article forming agent ejecting head 16, the water repellent material ejecting head 20 and the UV light source 22 are greater than or equal to the length of a formation surface, and configurations in which the surface modification head 21, the molded article forming agent ejecting head 16, the water repellent material ejecting head 20 and the UV light source 22 scan in either the X direction or the Y direction may also be used.

In addition, in the exemplary embodiment, in a case in which the shaping stand 34 gradually descends in the Z axis direction while the molded article forming agent ejecting head 16 and the like scan the XY plane, is described, but the shaping stand 34 may be fixed, and while the molded article forming agent ejecting head 16 and the like may gradually rise while scanning over the XY plane. In addition, both the molded article forming agent ejecting head 16 and the like and the shaping stand 34 may move in the Z axis direction so as to become separated from one another.

Additionally, the configuration of the stack forming apparatus 10 that is described in the exemplary embodiment is an example (refer to FIG. 1), and naturally, unnecessary portions may be eliminated and new portions may be added within a range that does not depart from the scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A stack forming apparatus comprising:
a molded article forming agent ejecting unit, that ejects a molded article forming agent for forming a three dimensional shaped product, onto a shaping stand;
a surface modification unit that modifies wettability of surfaces of the molded article forming agent; and
a control unit that controls the molded article forming agent ejecting section and the surface modification unit so that the three dimensional shaped product is formed by stacking the molded article forming agent through the repetition of ejection of the molded article forming agent and modification of the surface of the molded article forming agent.

2. The stack forming apparatus according to claim 1, further comprising:
a water repellent material ejecting unit that ejects a water repellent material,
wherein the control unit controls the water repellent material ejecting unit so that the water repellent material is ejected in a region that is adjacent to a region in which at least the molded article forming agent is ejected before the molded article forming agent is ejected.

3. The stack forming apparatus according to claim 2,
wherein the water repellent material is concurrently used as a support material for assisting in the forming of the three dimensional shaped product.

4. The stack forming apparatus according to claim 2,
wherein an amount of drops of the water repellent material, that is ejected from the water repellent material ejecting unit, is less than an amount of drops of the molded article forming agent that is ejected from the molded article forming agent ejecting section.

5. The stack forming apparatus according to claim 3,
wherein an amount of drops of the water repellent material, which is ejected from the water repellent material ejecting unit, is less than an amount of drops of the molded article forming agent that is ejected from the molded article forming agent ejecting section.

6. A non-transitory computer readable medium storing a stack forming program that causes a computer to function as a control unit of the stack forming apparatus according to claim 1.

7. A non-transitory computer readable medium storing a stack forming program that causes a computer to function as a control unit of the stack forming apparatus according to claim 2.
